(19) United States
(12) Patent Application Publication
(10) Pub. No.: US 2024/0385032 A1
(43) Pub. Date: Nov. 21, 2024

(54) OPTICAL FIBER SENSING SYSTEM, OPTICAL FIBER SENSING DEVICE, AND ROAD MONITORING METHOD

(71) Applicant: NEC Corporation, Minato-ku, Tokyo (JP)

(72) Inventors: Masatake TAKAHASHI, Tokyo (JP); Yuma MATSUDA, Tokyo (JP); Hitoshi Sakurai, Tokyo (JP)

(73) Assignee: NEC Corporation, Minato-ku, Tokyo (JP)

(21) Appl. No.: 18/690,792

(22) PCT Filed: Sep. 28, 2021
(86) PCT No.: PCT/JP2021/035596

§ 371 Date: Mar. 11, 2024

(51) Int. Cl. G01H 9/00; G08G 1/01; G08G 1/04

(52) U.S. Cl. CPC G01H 9/004; G08G 1/0116; G08G 1/04

(57) ABSTRACT

A system includes: a plurality of optical fibers provided corresponding to a plurality of lanes, respectively, along a road having the plurality of lanes; a sensing unit configured to receive, for each of the plurality of lanes, an optical signal from the optical fiber provided corresponding to the lane, and detect vibration generated by a vehicle traveling in the lane based on the optical signal; a vibration data calculation unit configured to calculate, for each of the plurality of lanes, vibration data indicating the vibration detected in the lane based on the optical signal received from the optical fiber provided corresponding to the lane; and a traveling state detection unit configured to detect, for each of the plurality of lanes, a traveling state of the vehicle traveling in the lane based on the vibration data calculated for the lane.

### TECHNICAL FIELD

The present disclosure relates to an optical fiber sensing system, an optical fiber sensing device, and a road monitoring method.

### BACKGROUND ART

In recent years, a system for monitoring a situation of a road has been proposed.

For example, Patent Literature 1 discloses that an impact sensor is fixed to a guardrail or the like of a road, and when a level of an electric signal output from the impact sensor is equal to or higher than a threshold, an accident detection signal indicating that a traffic accident has occurred is generated.

### CITATION LIST

### Patent Literature

Patent Literature 1: Japanese Unexamined Patent Application Publication No. 2000-227989

### SUMMARY OF INVENTION

### Technical Problem

Recently, there is a demand for detecting a traveling state of a vehicle traveling on a road. In particular, there is a demand for detecting a traveling state of a vehicle for each lane on a road having a plurality of lanes. However, the technology disclosed in Patent Literature 1 can only detect whether or not a traffic accident has occurred on a road.

Therefore, an object of the present disclosure is to solve the above-described problems and to provide an optical fiber sensing system, an optical fiber sensing device, and a road monitoring method capable of detecting a traveling state of a vehicle for each lane on a road having a plurality of lanes.

### Solution to Problem

An optical fiber sensing system according to an aspect includes:

a plurality of optical fibers provided corresponding to a plurality of lanes, respectively, along a road having the plurality of lanes;

a sensing unit configured to receive, for each of the plurality of lanes, an optical signal from the optical fiber provided corresponding to the lane, and detect vibration generated by a vehicle traveling in the lane based on the optical signal;

a vibration data calculation unit configured to calculate, for each of the plurality of lanes, vibration data indicating the vibration detected in the lane based on the optical signal received from the optical fiber provided corresponding to the lane; and

a traveling state detection unit configured to detect, for each of the plurality of lanes, a traveling state of the vehicle traveling in the lane based on the vibration data calculated for the lane.

An optical fiber sensing device according to an aspect includes:

a sensing unit configured to receive, for each of a plurality of lanes of a road, an optical signal from an optical fiber provided corresponding to the lane along the road, and detect vibration generated by a vehicle traveling in the lane based on the optical signal;

a vibration data calculation unit configured to calculate, for each of the plurality of lanes, vibration data indicating the vibration detected in the lane based on the optical signal received from the optical fiber provided corresponding to the lane; and

a traveling state detection unit configured to detect, for each of the plurality of lanes, a traveling state of the vehicle traveling in the lane based on the vibration data calculated for the lane.

A road monitoring method according to an aspect is

a road monitoring method by an optical fiber sensing device, the road monitoring method including:

a sensing step of receiving, for each of a plurality of lanes of a road, an optical signal from an optical fiber provided corresponding to the lane along the road, and detecting vibration generated by a vehicle traveling in the lane based on the optical signal;

a vibration data calculation step of calculating, for each of the plurality of lanes, vibration data indicating the vibration detected in the lane based on the optical signal received from the optical fiber provided corresponding to the lane; and

a traveling state detection step of detecting, for each of the plurality of lanes, a traveling state of the vehicle traveling in the lane based on the vibration data calculated for the lane.

### Advantageous Effects of Invention

According to the above-described aspects, it is possible to provide an optical fiber sensing system, an optical fiber sensing device, and a road monitoring method capable of detecting a traveling state of a vehicle for each lane on a road having a plurality of lanes.

### BRIEF DESCRIPTION OF DRAWINGS

FIG. 1 is a diagram illustrating a configuration example of an optical fiber sensing system according to a first example embodiment.

FIG. 2 is a diagram for describing an example of vibration data calculated by a vibration data calculation unit according to the first example embodiment.

FIG. 3 is a diagram for describing an example of a traveling state of a vehicle detected by a traveling state detection unit according to the first example embodiment.

FIG. 4 is a flowchart for describing a schematic operation example of the optical fiber sensing system according to the first example embodiment.

FIG. 5 is a diagram illustrating a configuration example of an optical fiber sensing system according to a second example embodiment.

FIG. 6 is a flowchart for describing a schematic operation example of the optical fiber sensing system according to the second example embodiment.

FIG. 7 is a diagram illustrating a configuration example of an optical fiber sensing device according to another example embodiment.

FIG. 8 is a block diagram illustrating a hardware configuration example of a computer that implements the optical fiber sensing device according to another example embodiment.

### EXAMPLE EMBODIMENT

Example embodiments of the present disclosure are described below with reference to the drawings. Note that in the description and drawings to be described below, omission and simplification are made as appropriate, for clarity of description. Furthermore, in the following drawings, the same elements will be denoted by the same reference signs, and redundant description will be omitted as necessary. In each of the following embodiments, a road R having three lanes L1 to L3 will be described as an example. Hereinafter, when it is not specified which of the lanes L1 to L3 is being referred to, it will be referred to as “lane L” as appropriate. Note that the number of lanes L of the road R is not limited to three, and may be two or more.

### First Example Embodiment

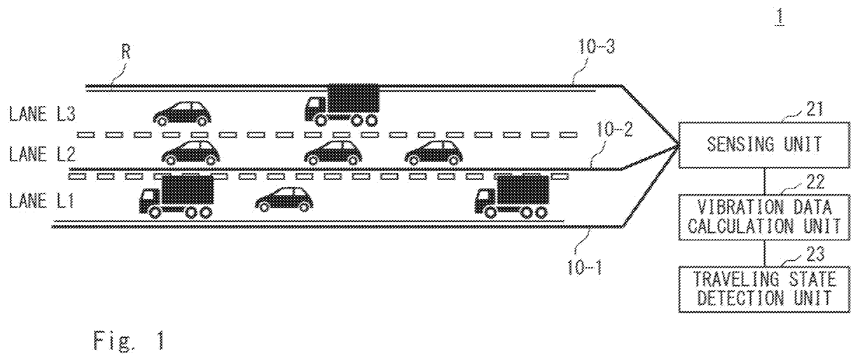

First, a configuration example of an optical fiber sensing system 1 according to a first example embodiment will be described with reference to FIG. 1.

As illustrated in FIG. 1, the optical fiber sensing system 1 according to the first example embodiment includes three optical fibers 10-1 to 10-3, a sensing unit 21, a vibration data calculation unit 22, and a traveling state detection unit 23. Hereinafter, when it is not specified that which of the optical fibers 10-1 to 10-3 is being referred to, it will be referred to as “optical fiber 10” as appropriate.

The optical fibers 10-1 to 10-3 are provided corresponding to the lanes L1 to L3, respectively, along the road R. In FIG. 1, one optical fiber 10 is provided in one lane L. However, a plurality of optical fibers 10 may be provided in one lane L. In FIG. 1, it is assumed that the optical fibers 10-1 to 10-3 are buried in the road R, but a method of laying the optical fibers 10-1 to 10-3 is not limited thereto. For example, the optical fibers 10-1 to 10-3 may be aerially wired to a structure such as a utility pole along the road R.

The sensing unit 21 is connected to the optical fibers 10-1 to 10-3 laid along the road R.

Therefore, the sensing unit 21 is installed near the road R. On the other hand, the vibration data calculation unit 22 and the traveling state detection unit 15 23 to be described later may be installed at any place, and may be arranged on a cloud, for example.

The sensing unit 21 causes pulsed light to be incident on the optical fiber 10-1 provided corresponding to the lane L1. In addition, the sensing unit 21 20 receives backscattered light generated as the pulsed light is transmitted through the optical fiber 10-1 as an optical signal via the optical fiber 10-1.

When the vehicle travels in the lane L1, vibration specific to traveling of the vehicle is generated, and the vibration is transmitted to the optical fiber 10-1 25 provided corresponding to the lane L1. As a result, characteristics (for example, a wavelength) of the optical signal transmitted through the optical fiber 10-1 are changed.

Therefore, the sensing unit 21 can detect the vibration generated by the vehicle traveling in the lane L1 based on the optical signal received from the optical fiber 10-1. 30

The sensing unit 21 also performs the same operation as described above for the lanes L2 and L3.

That is, the sensing unit 21 receives, for each of the lanes L1 to L3, the optical signal from the optical fiber 10 provided corresponding to the lane L and detects the vibration generated by the vehicle traveling in the lane L based on the optical signal.

The vibration data calculation unit 22 calculates vibration data indicating the vibration detected in the lane L1 by the sensing unit 21 based on the optical signal received from the optical fiber 10-1 provided corresponding to the lane L1. For example, the vibration data calculation unit 22 calculates the vibration data indicating the vibration detected in the lane L1 as follows.

First, the vibration data calculation unit 22 calculates a position and time at which the vibration detected by the sensing unit 21 has been generated in the lane L1.

Among the position and the time, the position at which the vibration has been generated is calculated as follows, for example.

For example, it is possible to calculate the position at which the optical signal is generated (a distance of the optical fiber 10-1 from the sensing unit 21) based on a time difference between a time at which the pulsed light is incident on the optical fiber 10-1 by the sensing unit 21 and a time at which the optical signal is received from the optical fiber 10-1 by the sensing unit 21.

Therefore, in a case where the sensing unit 21 detects the vibration in the lane L1 based on the optical signal received from the optical fiber 10-1, it is sufficient if the vibration data calculation unit 22 calculates the position at which the optical signal is generated by the above-described method, and set the calculated position as the position at which the vibration detected in the lane L1 is generated.

Then, the vibration data calculation unit 22 calculates, as the vibration data of the vibration detected in the lane L1, a graph with the horizontal axis representing the position at which the vibration detected in the lane L1 has been generated and the vertical axis representing the time at which the vibration detected in the lane L1 has been generated, based on the position and time at which the vibration detected in the lane L1 has been generated, the position and time being calculated as described above.

The vibration data calculation unit 22 also performs the same operation as described above for the lanes L2 and L3.

That is, the vibration data calculation unit 22 calculates, for each of the lanes L1 to L3, the vibration data indicating the vibration detected by the sensing unit 21 in the lane L based on the optical signal received from the optical fiber 10 provided corresponding to the lane L.

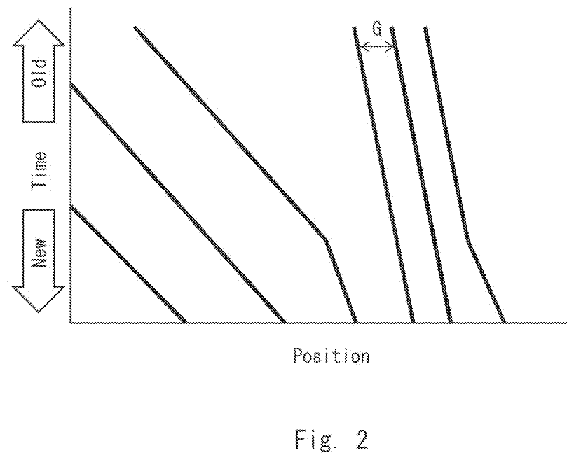

Here, an example of the vibration data calculated by the vibration data calculation unit 22 will be described with reference to FIG. 2. FIG. 2 illustrates an example of vibration data indicating vibration detected in a certain lane L (vibration detected in a traveling state different from that in FIG. 1). In FIG. 2, the horizontal axis represents the position at which the vibration has been generated (the distance of the optical fiber 10 from the sensing unit 21), and the vertical axis represents the time lapse of the time at which the vibration has been generated. In addition, the vertical axis indicates older data toward a positive direction.

In the vibration data illustrated in FIG. 2, the fact that one vehicle is traveling in the lane L over time is represented by one oblique line. An absolute value of an inclination of the line represents the vehicle speed of the vehicle, and the smaller the absolute value of the inclination of the line, the higher the vehicle speed of the vehicle. The positive and negative inclinations of the line represent a traveling direction of the vehicle. For example, in a case where there are a vehicle corresponding to a line with a positive inclination and a vehicle corresponding to a line with a negative inclination, the lines mean that the vehicles are traveling in opposite directions to each other (for example, traveling in opposite lanes). A change in inclination of the line indicates that the vehicle is accelerated or decelerated. Further, an interval G between the lines in a horizontal axis direction represents an inter-vehicle distance between the vehicles, and the shorter the interval G, the shorter the inter-vehicle distance.

The traveling state detection unit 23 detects, for each of the lanes L1 to L3, a traveling state of the vehicle traveling in the lane L based on the vibration data (for example, the vibration data as illustrated in FIG. 2) calculated by the vibration data calculation unit 22 for the lane L.

Specifically, the traveling state detection unit 23 detects, for each of the lanes L1 to L3, a vehicle speed and a position of each vehicle traveling in the lane L. In the lane L in the example of FIG. 2, six lines are illustrated, which means that six vehicles corresponding to the six lines are traveling. Therefore, the traveling state detection unit 23 detects the vehicle speed and the position for each of the six vehicles.

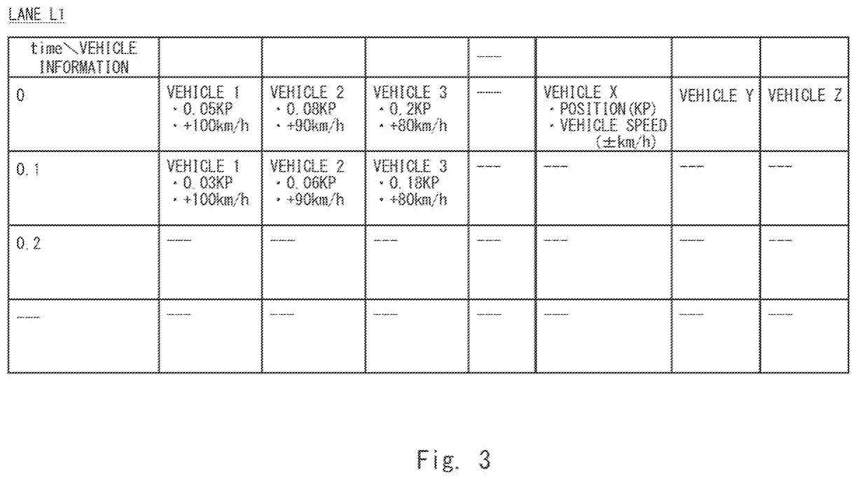

Here, an example of data of the vehicle speed and the position of each vehicle traveling in the lane L1 detected by the traveling state detection unit 23 will be described with reference to FIG. 3. In the example of FIG. 3, the data of the vehicle speed and the position of each vehicle traveling in the lane L1 is illustrated for each time. A traveling state at any time in FIG. 3 corresponds to the traveling state in FIG. 1. In the example of FIG. 3, a positive or negative sign indicating a traveling direction is added to the vehicle speed. In addition, for example, Vehicle 1 is a vehicle identifier (ID) that is valid only in this time zone, and Vehicles 1 at times 0 and 0.1 represent the same vehicle. The traveling state detection unit 23 also detects the traveling states in the lanes L2 and L3 to obtain data as illustrated in FIG. 3.

Note that, for each of the lanes L1 to L3, the traveling state detection unit 23 may not only detect the vehicle speed and the position of each vehicle traveling in the lane L, but also further detect an inter-vehicle distance between the vehicle and a preceding vehicle or a following vehicle. In addition, in a case where the inter-vehicle distance is detected, which of the preceding vehicle and the following vehicle is to be detected may be arbitrarily determined.

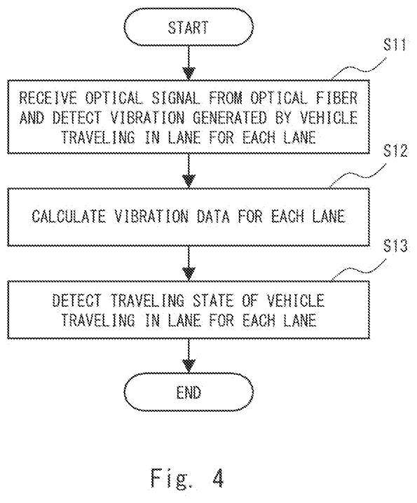

Subsequently, a schematic operation example of the optical fiber sensing system 1 according to the first example embodiment will be described with reference to FIG. 4.

As illustrated in FIG. 4, the sensing unit 21 receives, for each of the lanes L1 to L3, the optical signal from the optical fiber 10 provided corresponding to the lane L and detects the vibration generated by the vehicle traveling in the lane L based on the optical signal (step S11).

Next, the vibration data calculation unit 22 calculates, for each of the lanes L1 to L3, the vibration data indicating the vibration detected by the sensing unit 21 in the lane L based on the optical signal received from the optical fiber 10 provided corresponding to the lane L (step S12). For example, the vibration data calculation unit 22 calculates the vibration data as illustrated in FIG. 2 for each of the lanes L1 to L3.

Thereafter, the traveling state detection unit 23 detects, for each of the lanes L1 to L3, the traveling state of the vehicle traveling in the lane L based on the vibration data calculated by the vibration data calculation unit 22 for the lane

L (step S13). For example, the traveling state detection unit 23 detects the traveling state as illustrated in FIG. 3 for each of the lanes L1 to L3.

As described above, according to the first example embodiment, the sensing unit 21 receives, for each of the lanes L1 to L3, the optical signal from the optical fiber 10 provided corresponding to the lane L and detects the vibration generated by the vehicle traveling in the lane L based on the optical signal. The vibration data calculation unit 22 calculates, for each of the lanes L1 to L3, the vibration data indicating the vibration detected by the sensing unit 21 in the lane L based on the optical signal received from the optical fiber 10 provided corresponding to the lane L. The traveling state detection unit 23 detects, for each of the lanes L1 to L3, the traveling state of the vehicle traveling in the lane L based on the vibration data calculated by the vibration data calculation unit 22 for the lane L.

As a result, the traveling state of the vehicle can be detected for each lane L on the road R having the plurality of lanes L.

### Second Example Embodiment

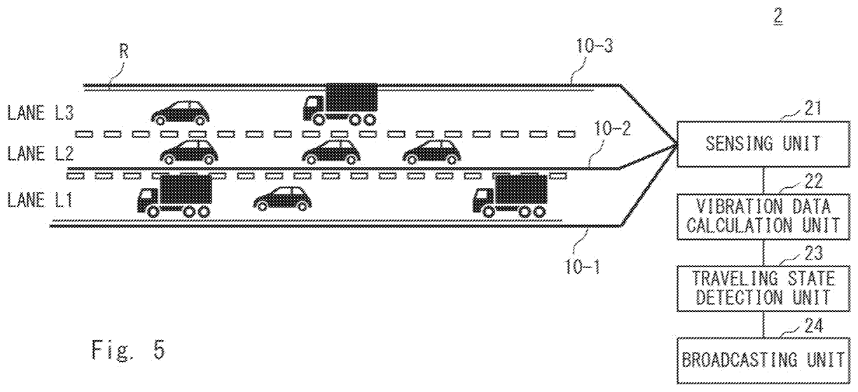

Next, a configuration example of an optical fiber sensing system 2 according to a second example embodiment will be described with reference to FIG. 5.

As illustrated in FIG. 5, the optical fiber sensing system 2 according to the second example embodiment is different from the above-described first example embodiment in that a broadcasting unit 24 is added.

The broadcasting unit 24 broadcasts a traveling state of a vehicle in each of lanes L1 to L3 detected by a traveling state detection unit 23 to a predetermined broadcasting destination. The predetermined broadcasting destination may be arbitrarily set. For example, in a case where the road R is an expressway, it is conceivable to set a road control center as the predetermined broadcasting destination. A broadcasting method may be any method. For example, the broadcasting method may be a method of displaying a graphical user interface (GUI) screen on a display, a monitor, or the like of a terminal of the broadcasting destination. Examples of the GUI screen include a GUI screen that displays data as illustrated in FIG. 3 for each of the lanes L1 to L3. In addition, the broadcasting method may be a method of outputting a message by voice from a speaker of the terminal of the broadcasting destination.

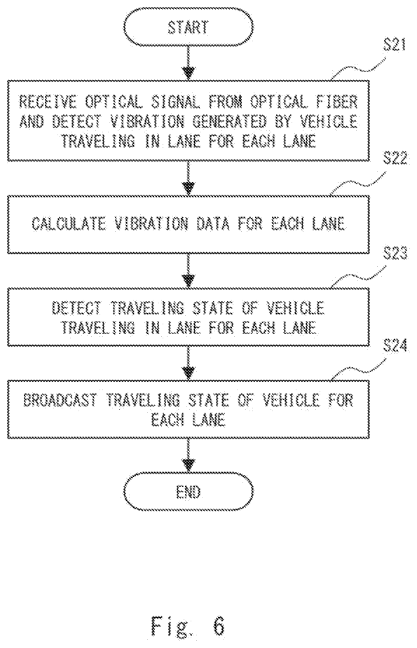

Subsequently, a schematic operation example of the optical fiber sensing system 2 according to the second example embodiment will be described with reference to FIG. 6.

As illustrated in FIG. 6, first, the processes of steps S21 to S23 similar to steps S11 to S13 of FIG. 4 are performed. Thereafter, the broadcasting unit 24 broadcasts the traveling state of the vehicle in each of the lanes L1 to L3 detected by the traveling state detection unit 23 to the predetermined broadcasting destination (step S24).

As described above, according to the second example embodiment, the broadcasting unit 24 broadcasts the traveling state of the vehicle in each of the lanes L1 to L3 detected by the traveling state detection unit 23 to the predetermined broadcasting destination.

As a result, the broadcasting destination can know the traveling state of the vehicle for each lane L on the road R having the plurality of lanes L.

### Another Example Embodiment

In the above-described first example embodiment, the sensing unit 21, the vibration data calculation unit 22, and the traveling state detection unit 23 are separately provided, but these components may be collectively provided in one device (optical fiber sensing device).

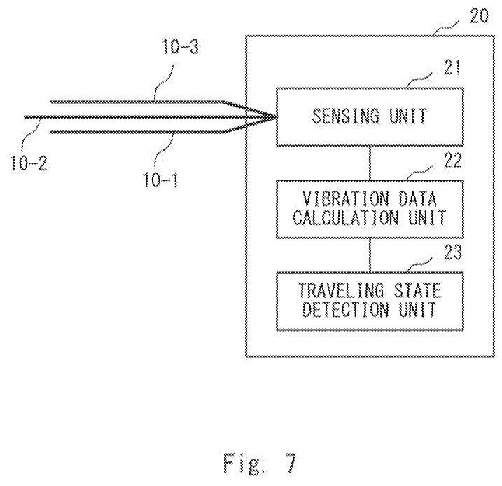

A configuration example of an optical fiber sensing device 20 according to another example embodiment will be described with reference to FIG. 7. As illustrated in FIG. 7, the optical fiber sensing device 20 according to another example embodiment includes a sensing unit 21, a vibration data calculation unit 22, and a traveling state detection unit 23. The optical fiber sensing device 20 may further include the broadcasting unit 24 according to the second example embodiment described above.

### Hardware Configuration of Optical Fiber Sensing Device According to Another Example Embodiment

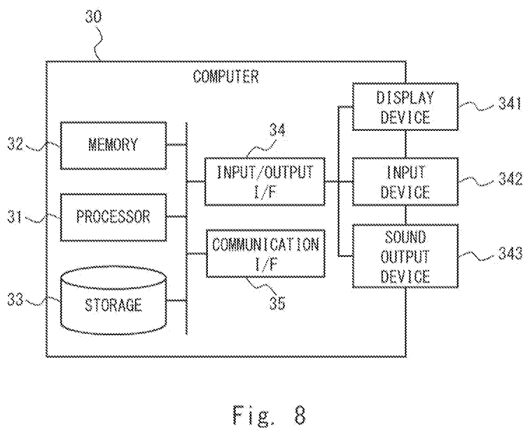

Subsequently, a hardware configuration example of a computer 30 that implements the optical fiber sensing device 20 according to the above-described another example embodiment is described with reference to FIG. 8.

As illustrated in FIG. 8, the computer 30 includes a processor 31, a memory 32, a storage 33, an input/output interface (input/output I/F) 34, and a communication interface (communication I/F) 35. The processor 31, the memory 32, the storage 33, the input/output interface 34, and the communication interface 35 are connected by a data transmission line for mutually transmitting or receiving data.

The processor 31 is an arithmetic processing apparatus such as a central processing unit (CPU) or a graphics processing unit (GPU). The memory 32 is a memory such as a random access memory (RAM) or a read only memory (ROM). The storage 33 is a storage device such as a hard disk drive (HDD), a solid state drive (SSD), or a memory card. Furthermore, the storage 33 may be a memory such as a RAM or a ROM.

A program is stored in the storage 33. This program includes a group of commands (or software code) for causing the computer 30 to execute one or more functions of the optical fiber sensing device 20 described above when being read by the computer. The sensing unit 21, the vibration data calculation unit 22, the traveling state detection unit 23, and the broadcasting unit 24 in the optical fiber sensing device 20 described above may be implemented by the processor 31 reading and executing a program stored in the storage 33. In addition, the storage function in the optical fiber sensing device 20 described above may be implemented by the memory 32 or the storage 33.

Furthermore, the program may be stored in a non-transitory computer readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 34 is connected to a display device 341, an input device 342, a sound output device 343, and the like. The display device 341 is a device that displays a screen corresponding to drawing data processed by the processor 31, such as a liquid crystal display (LCD), a cathode ray tube (CRT) display, or a monitor. The input device 342 is a device that receives an input of an operation of the operator, and is, for example, a keyboard, a mouse, a touch sensor, or the like. The display device 341 and the input device 342 may be integrated, and may be implemented as a touch panel. The sound output device 343 is a device that acoustically outputs sound corresponding to acoustic data that has been processed by the processor 31, such as a speaker.

The communication interface 35 transmits or receives data to and from an external device. For example, the communication interface 35 performs communication with the external device via a wired communication line or a wireless communication line.

Although the present disclosure has been described with reference to the example embodiments, the present disclosure is not limited to the example embodiments described above. Various modifications that can be understood by those skilled in the art can be made to the configuration and details of the present disclosure within the scope of the present disclosure.

Furthermore, some or all of the above example embodiments may be described as the following Supplementary Notes but are not limited to the following.

### Supplementary Note 1

An optical fiber sensing system including:

a plurality of optical fibers provided corresponding to a plurality of lanes, respectively, along a road having the plurality of lanes:

a sensing unit configured to receive, for each of the plurality of lanes, an optical signal from the optical fiber provided corresponding to the lane and detect vibration generated by a vehicle traveling in the lane based on the optical signal:

a vibration data calculation unit configured to calculate, for each of the plurality of lanes, vibration data indicating the vibration detected in the lane based on the optical signal received from the optical fiber provided corresponding to the lane; and

a traveling state detection unit configured to detect, for each of the plurality of lanes, a traveling state of the vehicle traveling in the lane based on the vibration data calculated for the lane.

### Supplementary Note 2

The optical fiber sensing system according to Supplementary Note 1, in which the vibration data calculation unit calculates, for each of the plurality of lanes, a position and a time at which the vibration detected in the lane has been generated based on the optical signal received from the optical fiber provided corresponding to the lane, and calculates, for each of the plurality of lanes, a graph with a horizontal axis representing the position at which the vibration detected in the lane has been generated and a vertical axis representing the time at which the vibration detected in the lane has been generated as the vibration data.

### Supplementary Note 3

The optical fiber sensing system according to Supplementary Note 1 or 2, in which the traveling state detection unit detects, for each of the plurality of lanes, a vehicle speed and a position of each vehicle traveling in the lane based on the vibration data calculated for the lane.

### Supplementary Note 4

The optical fiber sensing system according to Supplementary Note 3, in which the traveling state detection unit further detects, for each of the plurality of lanes, an inter-vehicle distance between each vehicle traveling in the lane and a preceding vehicle or a following vehicle based on the vibration data calculated for the lane.

### Supplementary Note 5

The optical fiber sensing system according to any one of Supplementary Notes 1 to 4, further including a broadcasting unit configured to broadcast the traveling state of the vehicle traveling in the lane to a predetermined broadcasting destination for each of the plurality of lanes.

### Supplementary Note 6

An optical fiber sensing device including:

a sensing unit configured to receive, for each of a plurality of lanes of a road, an optical signal from an optical fiber provided corresponding to the lane along the road, and detect vibration generated by a vehicle traveling in the lane based on the optical signal;

a vibration data calculation unit configured to calculate, for each of the plurality of lanes, vibration data indicating the vibration detected in the lane based on the optical signal received from the optical fiber provided corresponding to the lane: and

a traveling state detection unit configured to detect, for each of the plurality of lanes, a traveling state of the vehicle traveling in the lane based on the vibration data calculated for the lane.

### Supplementary Note 7

The optical fiber sensing device according to Supplementary Note 6, in which the vibration data calculation unit calculates, for each of the plurality of lanes, a position and a time at which the vibration detected in the lane has been generated based on the optical signal received from the optical fiber provided corresponding to the lane, and calculates, for each of the plurality of lanes, a graph with a horizontal axis representing the position at which the vibration detected in the lane has been generated and a vertical axis representing the time at which the vibration detected in the lane has been generated as the vibration data.

### Supplementary Note 8

The optical fiber sensing device according to Supplementary Note 6 or 7, in which the traveling state detection unit detects, for each of the plurality of lanes, a vehicle speed and a position of each vehicle traveling in the lane based on the vibration data calculated for the lane.

### Supplementary Note 9

The optical fiber sensing device according to Supplementary Note 8, in which the traveling state detection unit further detects, for each of the plurality of lanes, an inter-vehicle distance between each vehicle traveling in the lane and a preceding vehicle or a following vehicle based on the vibration data calculated for the lane.

### Supplementary Note 10

The optical fiber sensing device according to any one of Supplementary Notes 6 to 9, further including a broadcasting unit configured to broadcast the traveling state of the vehicle traveling in the lane to a predetermined broadcasting destination for each of the plurality of lanes.

### Supplementary Note 11

A road monitoring method by an optical fiber sensing device, the road monitoring method including:

a sensing step of receiving, for each of a plurality of lanes of a road, an optical signal from an optical fiber provided corresponding to the lane along the road, and detecting vibration generated by a vehicle traveling in the lane based on the optical signal:

a vibration data calculation step of calculating, for each of the plurality of lanes, vibration data indicating the vibration detected in the lane based on the optical signal received from the optical fiber provided corresponding to the lane: and

a traveling state detection step of detecting, for each of the plurality of lanes, a traveling state of the vehicle traveling in the lane based on the vibration data calculated for the lane.

### Supplementary Note 12

The road monitoring method according to Supplementary Note 11, in which

in the vibration data calculation step, a position and a time at which the vibration detected in the lane has been generated are calculated based on the optical signal received from the optical fiber provided corresponding to the lane for each of the plurality of lanes, and

a graph with a horizontal axis representing the position at which the vibration detected in the lane has been generated and a vertical axis representing the time at which the vibration detected in the lane has been generated is calculated as the vibration data for each of the plurality of lanes.

### Supplementary Note 13

The road monitoring method according to Supplementary Note 11 or 12, in which in the traveling state detection step, a vehicle speed and a position of each vehicle traveling in the lane are detected based on the vibration data calculated for the lane for each of the plurality of lanes.

### Supplementary Note 14

The road monitoring method according to Supplementary Note 13, in which in the traveling state detection step, an inter-vehicle distance between each vehicle traveling in the lane and a preceding vehicle or a following vehicle is further detected based on the vibration data calculated for the lane for each of the plurality of lanes.

### Supplementary Note 15

The road monitoring method according to any one of Supplementary Notes 11 to 14, further including a broadcasting step of broadcasting the traveling state of the vehicle traveling in the lane to a predetermined broadcasting destination for each of the plurality of lanes.

### REFERENCE SIGNS LIST

1, 2 OPTICAL FIBER SENSING SYSTEM
10-1 to 10-3 OPTICAL FIBER
20 OPTICAL FIBER SENSING DEVICE
21 SENSING UNIT
22 VIBRATION DATA CALCULATION UNIT
23 TRAVELING STATE DETECTION UNIT
24 BROADCASTING UNIT
30 COMPUTER
31 PROCESSOR
32 MEMORY
33 STORAGE
34 INPUT/OUTPUT INTERFACE
341 DISPLAY DEVICE
342 INPUT DEVICE
343 SOUND OUTPUT DEVICE
35 COMMUNICATION INTERFACE
R ROAD
L1 to L3 LANE

What is claimed is:

1. An optical fiber sensing system comprising:
a plurality of optical fibers provided corresponding to a plurality of lanes, respectively, along a road having the plurality of lanes;
at least one memory storing instructions, and
at least one processor configured to execute the instructions to;
receive, for each of the plurality of lanes, an optical signal from the optical fiber provided corresponding to the lane and detect vibration generated by a vehicle traveling in the lane based on the optical signal;
calculate, for each of the plurality of lanes, vibration data indicating the vibration detected in the lane based on the optical signal received from the optical fiber provided corresponding to the lane; and
detect, for each of the plurality of lanes, a traveling state of the vehicle traveling in the lane based on the vibration data calculated for the lane.

2. The optical fiber sensing system according to claim 1, wherein the at least one processor is further configured to execute the instructions to calculate, for each of the plurality of lanes, a position and a time at which the vibration detected in the lane has been generated based on the optical signal received from the optical fiber provided corresponding to the lane, and calculate, for each of the plurality of lanes, a graph with a horizontal axis representing the position at which the vibration detected in the lane has been generated and a vertical axis representing the time at which the vibration detected in the lane has been generated as the vibration data.

3. The optical fiber sensing system according to claim 1, wherein the at least one processor is further configured to execute the instructions to detect, for each of the plurality of lanes, a vehicle speed and a position of each vehicle traveling in the lane based on the vibration data calculated for the lane.

4. The optical fiber sensing system according to claim 3, wherein the at least one processor is further configured to execute the instructions to further detect, for each of the plurality of lanes, an inter-vehicle distance between each vehicle traveling in the lane and a preceding vehicle or a following vehicle based on the vibration data calculated for the lane.

5. The optical fiber sensing system according to claim 1, wherein the at least one processor is further configured to execute the instructions to broadcast the traveling state of the vehicle traveling in the lane to a predetermined broadcasting destination for each of the plurality of lanes.

6. An optical fiber sensing device comprising:
at least one memory storing instructions, and
at least one processor configured to execute the instructions to;
receive, for each of a plurality of lanes of a road, an optical signal from an optical fiber provided corresponding to the lane along the road, and detect vibration generated by a vehicle traveling in the lane based on the optical signal;
calculate, for each of the plurality of lanes, vibration data indicating the vibration detected in the lane based on the optical signal received from the optical fiber provided corresponding to the lane; and
detect, for each of the plurality of lanes, a traveling state of the vehicle traveling in the lane based on the vibration data calculated for the lane.

7. The optical fiber sensing device according to claim 6, wherein the at least one processor is further configured to execute the instructions to calculate, for each of the plurality of lanes, a position and a time at which the vibration detected in the lane has been generated based on the optical signal received from the optical fiber provided corresponding to the lane, and calculate, for each of the plurality of lanes, a graph with a horizontal axis representing the position at which the vibration detected in the lane has been generated and a vertical axis representing the time at which the vibration detected in the lane has been generated as the vibration data.

8. The optical fiber sensing device according to claim 6, wherein the at least one processor is further configured to execute the instructions to detect, for each of the plurality of lanes, a vehicle speed and a position of each vehicle traveling in the lane based on the vibration data calculated for the lane.

9. The optical fiber sensing device according to claim 8, wherein the at least one processor is further configured to execute the instructions to further detect, for each of the plurality of lanes, an inter-vehicle distance between each vehicle traveling in the lane and a preceding vehicle or a following vehicle based on the vibration data calculated for the lane.

10. The optical fiber sensing device according to claim 6, wherein the at least one processor is further configured to execute the instructions to broadcast the traveling state of the vehicle traveling in the lane to a predetermined broadcasting destination for each of the plurality of lanes.

11. A road monitoring method by an optical fiber sensing device, the road monitoring method comprising:
a sensing step of receiving, for each of a plurality of lanes of a road, an optical signal from an optical fiber provided corresponding to the lane along the road, and detecting vibration generated by a vehicle traveling in the lane based on the optical signal;
a vibration data calculation step of calculating, for each of the plurality of lanes, vibration data indicating the vibration detected in the lane based on the optical signal received from the optical fiber provided corresponding to the lane; and
a traveling state detection step of detecting, for each of the plurality of lanes, a traveling state of the vehicle traveling in the lane based on the vibration data calculated for the lane.

12. The road monitoring method according to claim 11, wherein
in the vibration data calculation step, a position and a time at which the vibration detected in the lane has been generated are calculated based on the optical signal received from the optical fiber provided corresponding to the lane for each of the plurality of lanes, and
a graph with a horizontal axis representing the position at which the vibration detected in the lane has been generated and a vertical axis representing the time at which the vibration detected in the lane has been generated is calculated as the vibration data for each of the plurality of lanes.

13. The road monitoring method according to claim 11, wherein in the traveling state detection step, a vehicle speed and a position of each vehicle traveling in the lane are detected based on the vibration data calculated for the lane for each of the plurality of lanes.

14. The road monitoring method according to claim 13, wherein in the traveling state detection step, an inter-vehicle distance between each vehicle traveling in the lane and a preceding vehicle or a following vehicle is further detected based on the vibration data calculated for the lane for each of the plurality of lanes.

15. The road monitoring method according to claim 11, further comprising a broadcasting step of broadcasting the traveling state of the vehicle traveling in the lane to a predetermined broadcasting destination for each of the plurality of lanes.
